(19) United States
(12) Patent Application Publication
(10) Pub. No.: US 2017/0184348 A1
(43) Pub. Date: Jun. 29, 2017

(54) Automobile Interior Temperature Stabilizer

(71) Applicant: Roger Li-Chung Wu, West Covina, CA (US)

(72) Inventor: Roger Li-Chung Wu, West Covina, CA (US)

(21) Appl. No.: 14/981,868

(22) Filed: Dec. 28, 2015

(51) Int. Cl. F28D 20/02; B60H 1/00

(52) U.S. Cl. CPC F28D 20/02; B60H 1/00321

(57) ABSTRACT

An automobile interior temperature stabilizer includes a holder adapted for placing within a vehicle cabin and a temperature stabilizing member which is made of latent heat material that absorbs and releases heat without rising in its temperature and is disposed in the holder, wherein the temperature stabilizing member has a threshold temperature range that the temperature stabilizing member is arranged for absorbing cabin heat within the vehicle cabin to cool down the vehicle cabin when an interior temperature of the vehicle is higher than the threshold temperature range, and the temperature stabilizing member is arranged for releasing stored heat to the vehicle cabin to warm the vehicle cabin when an interior temperature of the vehicle is lower than the threshold temperature range. Therefore, the automobile interior temperature stabilizer is able to maintain the cabin temperature of the vehicle without using any power from the vehicle.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

The present invention relates to a vehicle cabin control, and more particular to an automobile interior temperature stabilizer, which can maintain a cabin temperature of a vehicle at an optimum comfort level in a power free manner.

Description of Related Arts

It is known that exposing a vehicle to high temperature will heat up the vehicle cabin, wherein the cabin temperature of the vehicle can reach 150° F.-200° F. that is greater than the ambient temperature outside the vehicle. High temperature in the vehicle cabin can melt the plastic surface of the dashboard, crack the leather seat surface, and even cause the malfunction of any electronic component.

The vehicle usually comprises a climate control, such as a heating, ventilating and air conditioning (HAVC) system, to control the cabin temperature and to make the driver and/or passengers comfortable. However, the climate control has several drawbacks. The engine of the vehicle must be started in order to switch on the climate control for safety issue. It is a waste of fuel to drop the initial cabin temperature of the vehicle before driving. In other words, the climate control of the vehicle is not designed for cooling the vehicle cabin when the vehicle is parked.

Placing a windshield sun shade inside and against the windshield of the vehicle can block the excessive heat directly entering thereinto through the windshield. However, excessive heat will gradually build up inside the vehicle cabin. There are numerous cases showed that many young children died after they were accidentally left in a hot vehicle. A need exists for the vehicle that retains all of its cabin temperature control and environmentally friendly attributes and while allowing an interior of a parked vehicle to be cooled down. It is to the provision of such a temperature stabilizer that the present disclosure is primarily directed.

### SUMMARY OF THE PRESENT INVENTION

The invention is advantageous in that it provides an automobile interior temperature stabilizer, which can maintain a cabin temperature of a vehicle at an optimum comfort level in a power free manner.

Another advantage of the invention is to an automobile interior temperature stabilizer, wherein the temperature stabilizing member absorbs and releases heat without rising in its temperature, such that it is safe for the user to touch the temperature stabilizing member after heat absorption.

Another advantage of the invention is to an automobile interior temperature stabilizer, wherein the temperature stabilizing member can be incorporated with any vehicle accessory to be placed within the vehicle cabin and can be built-in with any interior cabin component of the vehicle to stabilize the interior temperature of the vehicle.

Another advantage of the invention is to an automobile interior temperature stabilizer, wherein no external power, such as electrical power or battery, is required for operating the temperature stabilizing member, such that the operating cost of the present invention will be minimized.

Another advantage of the invention is to an automobile interior temperature stabilizer, wherein the temperature stabilizing member is made of non-inflammable material, such that the present invention is safe to use and place in the vehicle cabin.

Another advantage of the invention is to provide an automobile interior temperature stabilizer, which does not require altering the original structural design of the vehicle accessory and/or the interior cabin component of the vehicle, so as to minimize the manufacturing cost of the vehicle accessory and/or the interior cabin component of the vehicle that incorporates the automobile interior temperature stabilizer.

Another advantage of the invention is to an automobile interior temperature stabilizer, wherein no expensive or complicated structure is required to employ in the present invention in order to achieve the above mentioned objects. Therefore, the present invention successfully provides an economic and efficient solution for maintaining the cabin temperature of the vehicle without using any power from the vehicle.

Additional advantages and features of the invention will become apparent from the description which follows, and may be realized by means of the instrumentalities and combinations particular point out in the appended claims.

According to the present invention, the foregoing and other objects and advantages are attained by an automobile interior temperature stabilizer, comprising:

a holder adapted for placing within a vehicle cabin; and

a temperature stabilizing member which is made of latent heat material that absorbs and releases heat without rising in its temperature and is disposed in the holder, wherein the temperature stabilizing member has a threshold temperature range that the temperature stabilizing member is arranged for absorbing cabin heat within the vehicle cabin to cool down the vehicle cabin when an interior temperature of the vehicle is higher than the threshold temperature range, and the temperature stabilizing member is arranged for releasing stored heat to the vehicle cabin to warm the vehicle cabin when an interior temperature of the vehicle is lower than the threshold temperature range.

In accordance with another aspect of the invention, the present invention comprises a vehicle which comprises an interior cabin component within a vehicle cabin and a temperature stabilizing member built-in with the interior cabin component for maintaining the cabin temperature of the vehicle.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an automobile interior temperature stabilizer according to a preferred embodiment of the present invention.

FIG. 2 is a sectional view of the automobile interior temperature stabilizer incorporating with a vehicle accessory according to the above preferred embodiment of the present invention, illustrating the vehicle accessory as a tissue box holder.

FIG. 3 is a perspective view of the automobile interior temperature stabilizer incorporating with a vehicle accessory according to the above preferred embodiment of the present invention, illustrating the vehicle accessory as a car seat cushion.

FIG. 4 is a perspective view of the automobile interior temperature stabilizer incorporating with a vehicle accessory according to the above preferred embodiment of the present invention, illustrating the vehicle accessory as a car seat cover.

FIG. 5 is a perspective view of the automobile interior temperature stabilizer built-in with the interior cabin component according to the above preferred embodiment of the present invention, illustrating the automobile interior temperature stabilizer embedded within an interior roof lining of the vehicle.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

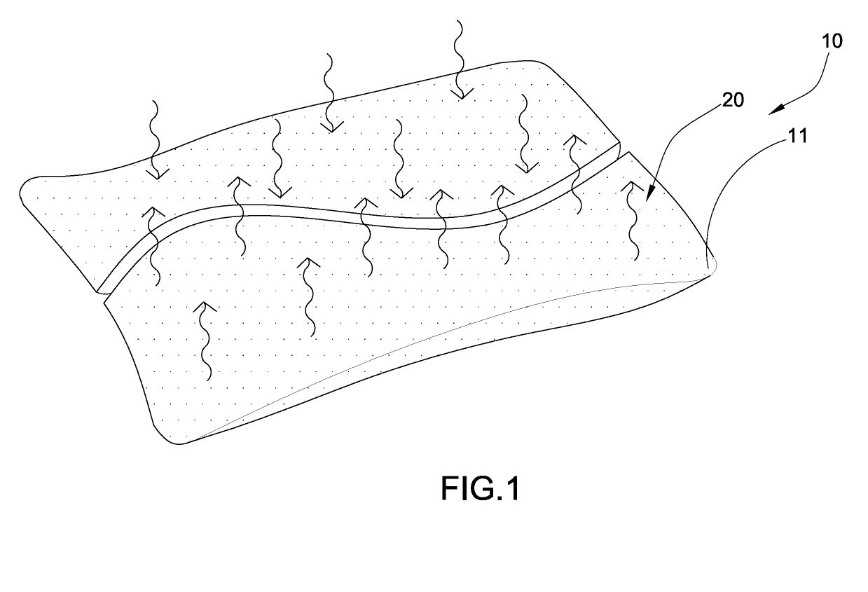

Referring to FIG. 1 of the drawings, an automobile interior temperature stabilizer for a vehicle according to a preferred embodiment of the present invention is illustrated. The automobile interior temperature stabilizer comprises a holder 10 and a temperature stabilizing member 20.

According to the preferred embodiment, the holder 10 is arranged for placing within a vehicle cabin of the vehicle. The holder 10 can be designed as a vehicle accessory for placing in the vehicle cabin of the vehicle. Accordingly, the holder 10 comprises a sealing pack 11 made of air breathable material that seals and carry the temperature stabilizing member 20 in the sealing pack 11.

The temperature stabilizing member 20 is disposed in the holder 10. Preferably, the temperature stabilizing member 20 is sealed in the sealing pack 11. According to the preferred embodiment, the temperature stabilizing member 20 is made of latent heat material that absorbs and releases heat without rising in its temperature. In other words, the temperature stabilizing member 20 is safe to touch when it absorbs heat.

In particular, the temperature stabilizing member 20 has a threshold temperature range. The temperature stabilizing member 20 is located within the vehicle cabin of the vehicle for maintaining the cabin temperature of the vehicle. The temperature stabilizing member 20 is arranged for absorbing cabin heat within the vehicle cabin to cool down the vehicle cabin when an interior temperature of the vehicle is higher than the threshold temperature range. In addition, the temperature stabilizing member 20 is arranged for releasing stored heat to the vehicle cabin to warm the vehicle cabin when an interior temperature of the vehicle is lower than the threshold temperature range.

The temperature stabilizing member 20 can be formed in solid state or liquid state. Accordingly, the temperature stabilizing member 20 can be made of graphene which is a monolayer of carbon atoms arranged in a honeycomb pattern. Graphene has a relatively high heat storage capacity and can serves as a graphene layer held by the holder 10 for heat absorption. Scientists found that graphene located at a hotspot with a range from 130° F. to 240 ° F. can drop up to 50° F. Therefore, when graphene as the temperature stabilizing member 20 is located within the vehicle cabin at high cabin temperature, the cabin temperature could be dropped depending the amount of graphene being used.

It is appreciated that the temperature stabilizing member 20 can be made of phase change material (PCM) that a saturation temperature and a freezing temperature of the temperature stabilizing member 20 fall within the threshold temperature range. That is, when the interior temperature of the vehicle is higher than the saturation temperature of the temperature stabilizing member 20, the temperature stabilizing member 20 will absorb cabin heat. When the interior temperature of the vehicle is lower than the freezing temperature of the temperature stabilizing member 20, the temperature stabilizing member 20 will release stored heat.

Accordingly, the temperature stabilizing member 20 can be calcium chloride, sodium sulfate dehydrate, and propylene glycol with sodium carboxymethyl cellulose. The temperature stabilizing member 20, which is made of phase change material (PCM), will collect heat during the day (high temperature), and will release heat at night (low temperature) to provide an optimal cabin temperature, resulting in energy efficiency and cost saving.

Alternatively, the temperature stabilizing member 20 can be made of various waxes which can be tailored to start melting and freezing at about room temperature. Within a high temperature of the vehicle cabin, the wax can absorb heat therewithin while the temperature of wax itself will remain constant at its melting temperature, so as to keep the vehicle cabin comfortably cool.

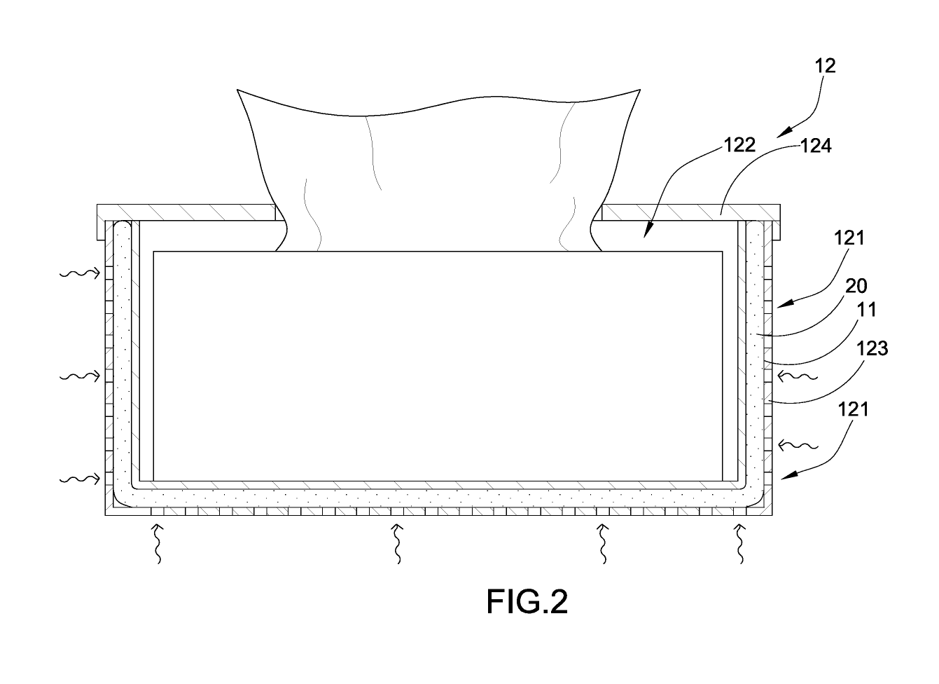

As shown in FIG. 2, the a temperature stabilizing member 20 is incorporated the holder 10 to serves as the vehicle accessory. In particular, the holder 10 further comprises a casing 12 having a plurality of vent slots 121 provided thereat, wherein the temperature stabilizing member 20 is retained in the casing 12. Accordingly, the casing 12 can be a hard casing or a soft casing. Preferably, the sealing pack 11 with the temperature stabilizing member 20 therein is replaceably disposed in the casing 12. Therefore, the temperature stabilizing member 20 is retained in the casing 12 for absorbing the cabin heat from the cabin vehicle through the vent slots 121 and for releasing the stored heat to the cabin vehicle through the vent slots 121.

It is worth mentioning that the holder 10 can serves as a tissue box holder as one of the vehicle accessories for being placed in the vehicle, wherein the casing 12 further has a tissue box cavity 122 for replaceably receiving a tissue box. As shown in FIG. 2, the casing 12 comprises a casing base 123 and a casing cover 124 detachably coupled to the casing base 123 to define the tissue box cavity 122 within the casing base 123 and the casing cover 124, wherein the casing base 123 has a double-wall structure to retain the temperature stabilizing member 20 between an outer wall and an inner wall of the casing base 123. In particular, the vent slots 121 are spacedly formed at the outer wall of the casing base 123 to enable the temperature stabilizing member 20 to absorb the cabin heat and to release the stored heat via the vent slots 121.

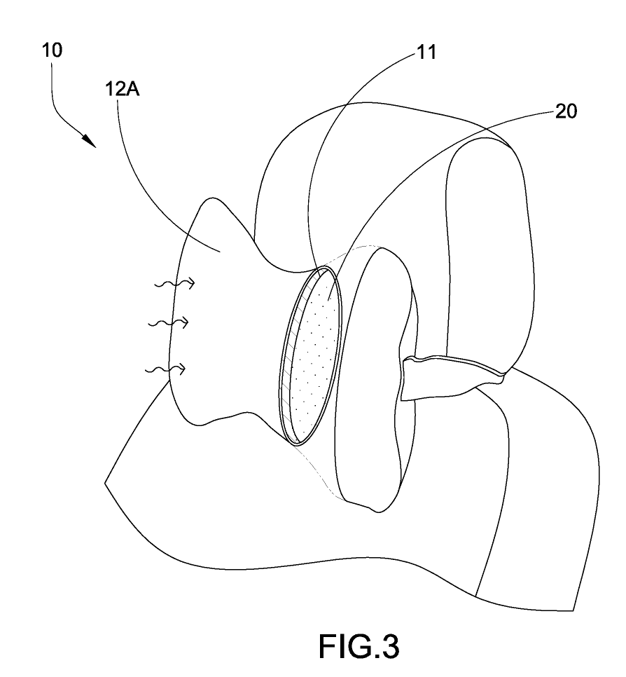

FIG. 3 illustrates an alternative mode of the automobile interior temperature stabilizer, wherein the holder 10 can serves as a headrest cushioning device as one of the vehicle accessories for being placed in the vehicle. In particular, the holder 10 comprises a headrest cushion 12A for detachably coupling at a headrest of the vehicle, wherein the sealing pack 11 with the temperature stabilizing member 20 is embedded in the headrest cushion 12A. It is worth mentioning that the outer skin of the headrest cushion 12A is made of air-breathable fabric, wherein the sealing pack 11 with the temperature stabilizing member 20 is wrapped within the outer skin of the headrest cushion 12A, such that the temperature stabilizing member 20 can absorb the cabin heat from the cabin vehicle and can release the stored heat to the cabin vehicle through the outer skin of the headrest cushion 12A.

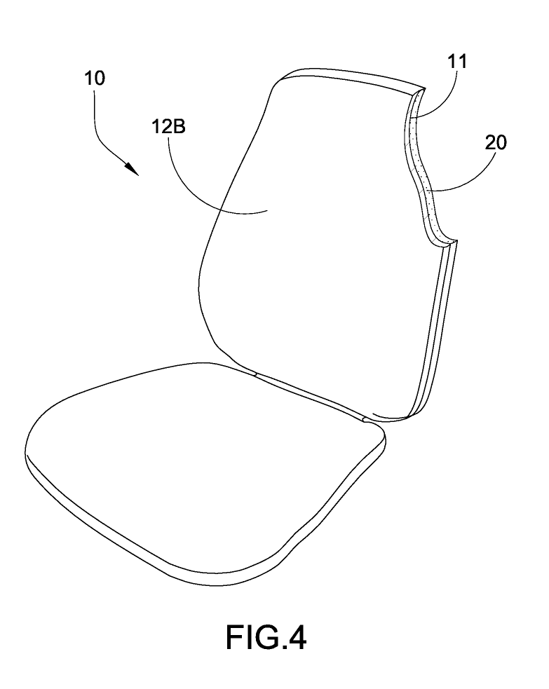

FIG. 4 illustrates a second alternative mode of the automobile interior temperature stabilizer, wherein the holder 10 can serves as a car seat protection device as one of the vehicle accessories for being placed in the vehicle. In particular, the holder 10 comprises a car seat cover 12B for removably place on a car seat of the vehicle, wherein the sealing pack 11 with the temperature stabilizing member 20 is embedded in the car seat cover 12B. It is worth mentioning that the outer skin of the car seat cover 12B is made of air-breathable fabric, wherein the sealing pack 11 with the temperature stabilizing member 20 is wrapped within the outer skin of the car seat cover 12B, such that the temperature stabilizing member 20 can absorb the cabin heat from the cabin vehicle and can release the stored heat to the cabin vehicle through the outer skin of the car seat cover 12B. The car seat cover 12B can also provide a cushioning effect as well when the car seat cover 12B is overlapped on the car seat of the vehicle. It is appreciated that the car seat protection can be used for a baby car seat.

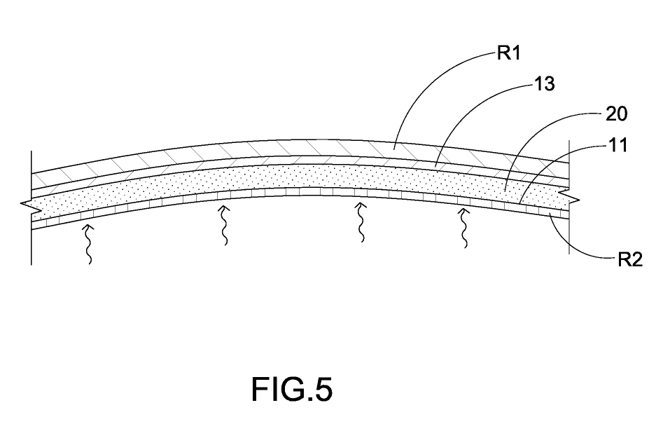

FIG. 5 illustrates a third alternative mode of the automobile interior temperature stabilizer, which can be built-in with any interior cabin component within the vehicle cabin. For example, the sealing pack 11 with the temperature stabilizing member 20 is embedded in an interior roof lining R2 of the vehicle. It is worth mentioning that the roof structure of the vehicle generally comprises a roof panel R1 and the interior roof lining R2 overlapped under the roof panel. The temperature stabilizing member 20 is sandwiched between the roof panel R1 and the interior roof lining R2. Preferably, a thermal insulating layer 13 is sandwiched between the roof panel R1 and the temperature stabilizing member 20 for preventing the heat transmitting to the temperature stabilizing member 20 through the roof panel R1, especially when directly exposing the roof panel R1 to high temperature.

It should be appreciated that the temperature stabilizing member 20 can be built-in with different interior cabin components within the vehicle cabin, such as an interior door lining of the vehicle or the dashboard of the vehicle.

Through the thermal properties of the temperature stabilizing member 20, the temperature stabilizing member 20 can self-absorb the cabin heat and self-release the store heat to maintain the cabin temperature of the vehicle at an optimum comfort level. Thus, no external power, such as electrical power from the vehicle, is required for operation. Especially when the vehicle is parked under a hot summer day, the temperature stabilizing member 20 can self-absorb the cabin heat without powering on the vehicle. During nighttime, the temperature stabilizing member 20 will release the stored heat to the vehicle cabin to keep the vehicle cabin warm. Therefore, the automobile interior temperature stabilizer of the present invention successfully provides an economic and efficient solution for maintaining the cabin temperature of the vehicle without using any power from the vehicle.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An automobile interior temperature stabilizer, comprising:
a holder adapted for placing within a vehicle cabin; and
a temperature stabilizing member which is made of latent heat material that absorbs and releases heat without rising in its temperature and is disposed in said holder, wherein said temperature stabilizing member has a threshold temperature range that said temperature stabilizing member is arranged for absorbing cabin heat within the vehicle cabin to cool down the vehicle cabin when an interior temperature of the vehicle is higher than said threshold temperature range, and said temperature stabilizing member is arranged for releasing stored heat to the vehicle cabin to warm the vehicle cabin when an interior temperature of the vehicle is lower than said threshold temperature range.

2. The automobile interior temperature stabilizer, as recited in claim 1, wherein said holder comprises a sealing pack made of air breathable material that seals and carry said temperature stabilizing member in said sealing pack.

3. The automobile interior temperature stabilizer, as recited in claim 1, wherein said holder comprises a casing having a plurality of vent slots provided thereat, wherein said temperature stabilizing member is retained in said casing for absorbing the cabin heat from the cabin vehicle and for releasing the stored heat to the cabin vehicle through said vent slots.

4. The automobile interior temperature stabilizer, as recited in claim 2, wherein said holder comprises a casing having a plurality of vent slots provided thereat, wherein said temperature stabilizing member is retained in said casing for absorbing the cabin heat from the cabin vehicle and for releasing the stored heat to the cabin vehicle through said vent slots.

5. The automobile interior temperature stabilizer, as recited in claim 4, wherein said sealing pack is disposed in said casing.

6. The automobile interior temperature stabilizer, as recited in claim 1, wherein said temperature stabilizing member is made of phase change material (PCM) that a saturation temperature of said temperature stabilizing member falls within said threshold temperature range.

7. The automobile interior temperature stabilizer, as recited in claim 5, wherein said temperature stabilizing member is made of phase change material (PCM) that a saturation temperature of said temperature stabilizing member falls within said threshold temperature range.

8. The automobile interior temperature stabilizer, as recited in claim 6, wherein said temperature stabilizing member is selected from the group consisting of calcium chloride, sodium sulfate dehydrate, and propylene glycol with sodium carboxymethyl cellulose.

9. The automobile interior temperature stabilizer, as recited in claim 7, wherein said temperature stabilizing member is selected from the group consisting of calcium chloride, sodium sulfate dechydrate, and propylene glycol with sodium carboxymethyl cellulose.

10. The automobile interior temperature stabilizer, as recited in claim 1, wherein said temperature stabilizing member is made of wax material.

11. The automobile interior temperature stabilizer, as recited in claim 5, wherein said temperature stabilizing member is made of wax material.

12. The automobile interior temperature stabilizer, as recited in claim 1, wherein said temperature stabilizing member is made of graphene.

13. The automobile interior temperature stabilizer, as recited in claim 5, wherein said temperature stabilizing member is made of graphene.

14. The automobile interior temperature stabilizer, as recited in claim 3, wherein said casing further has a tissue box cavity for replaceably receiving a tissue box, such that said casing forms a vehicle accessory for being placed in the vehicle.

15. The automobile interior temperature stabilizer, as recited in claim 5, wherein said casing further has a tissue box cavity for replaceably receiving a tissue box, such that said casing forms a vehicle accessory for being placed in the vehicle.

16. The automobile interior temperature stabilizer, as recited in claim 2, wherein said holder comprises a headrest cushion for detachably coupling at a headrest of the vehicle, wherein said sealing pack is embedded in said headrest cushion.

17. The automobile interior temperature stabilizer, as recited in claim 2, wherein said holder comprises a car seat cover for removably place on a car seat of the vehicle, wherein said sealing pack is embedded in said car seat cover.

18. The automobile interior temperature stabilizer, as recited in claim 2, wherein said sealing pack is embedded in an interior roof lining of the vehicle.

19. A vehicle, comprising:
an interior cabin component within a vehicle cabin; and
a temperature stabilizing member which is made of latent heat material that absorbs and releases heat without rising in its temperature and is built-in with said interior cabin component, wherein said temperature stabilizing member has a threshold temperature range that said temperature stabilizing member is arranged for absorbing cabin heat within the vehicle cabin to cool down the vehicle cabin when an interior temperature of the vehicle is higher than said threshold temperature range, and said temperature stabilizing member is arranged for releasing stored heat to the vehicle cabin to warm the vehicle cabin when an interior temperature of the vehicle is lower than said threshold temperature range.

20. The vehicle, as recited in claim 19, wherein said temperature stabilizing member is selected from the group consisting of graphene, wax material, calcium chloride, sodium sulfate dehydrate, and propylene glycol with sodium carboxymethyl cellulose.
